(19) United States
(12) Patent Application Publication
(10) Pub. No.: US 2018/0315011 A1
(43) Pub. Date: Nov. 1, 2018

(54) Limited Spatial Digital Directory with Physical Navigation for Optimizing Smart Carts

(71) Applicants: John Clarke, Washington, DC (US); James Clarke, Washington, DC (US); Paul Clarke, Washington, DC (US)

(72) Inventors: John Clarke, Washington, DC (US); James Clarke, Washington, DC (US); Paul Clarke, Washington, DC (US)

(21) Appl. No.: 15/903,042

(22) Filed: Feb. 23, 2018

Related U.S. Application Data
(60) Provisional application No. 62/462,861, filed on Feb. 23, 2017.

(51) Int. Cl. G06Q 10/08; G06K 7/14; G06Q 20/20

(52) U.S. Cl. CPC G06Q 10/087; G06Q 20/208; G06K 7/1413

(57) ABSTRACT

The present disclosure relates to a program or system for navigating a store or handling and locating inventory within a store. This application has several embodiments including but not limited to those where the program operates on a computerized console directly docked on a store cart, a mobile device tethered to a store cart, or any combination of the two. Security features, charging features (using energy including but not limited synergistically charged batteries or solar panels) scanning features, geospatial features and other peripheral device enabled features are disclosed in the multiple embodiments of the disclosure. For use with a smart cart the invention disclosed herein can greatly enhance a shopping experience, allowing for efficient shopping, with features like phone charging, simplified item location and purchasing for shoppers and ease of inventory management, cart-maintenance, and security for shop keepers.

### CROSS-REFERENCE TO RELATED APPLICATION

This application claims the benefit of U.S. Provisional Application No. 62/462,861 filed Feb. 23, 2017. The entire disclosure of U.S. Provisional Application No. 62/462,861 is incorporated herein by reference.

### TECHNICAL FIELD

The general field of the disclosure herein relates to methods, systems, or apparatuses involving interactive carts with built in computerized features or carts that may be synchronized with devices containing computerized features, such that data and/or energy may be shared between these devices.

### BACKGROUND

Technology is spreading at a rapid pace, with cell phone usage tripling throughout the world over the past decade (see e.g. Mobile Cellular Subscriptions 2000-2014 International Telecommunication Union, http://www.itu.int/en/ITU-D/Statistics/Pages/stat/default.aspx, visited Jan. 10, 2016). In the shopping cart industry technology has not moved as rapidly.

### SUMMARY OF THE INVENTION

Exemplary embodiments of the present disclosure relate to a system of transportation devices such as those used for the transportation of goods, including but not limited to shopping carts, shopping baskets and propulsion vehicles, which in the embodiments of the present disclosure may be designed to interface with mobile devices to transmit electronic features to and from said mobile devices including but not limited to data, power, or security features. Data may be defined as information including but not limited to the layout of a particular store, the store inventory, the location of a particular item in the store or marketplace, data regarding the cart the location of the user, pricing information, user payment information, user input information or advertising or user favorites based on past selections, browsing habits, consumption habits or other past data. This data may be used to guide a user to a particular item in a store via systems including but not limited to the mobile device's GPS, gyrometer, inertial sensor or other directional or position based technology. Power may be defined as electrical energy that may be supplied to a battery, a docking station or to a mobile device directly. Power may be provided to charge a battery in a transportation device such as a cart via solar energy while it's docked to a solar return cart station outdoors, via synergistic energy while the user pushes the cart, or via a plugin outlet while the cart is resting in a garage. In some embodiments of the present disclosure energy from said battery may be used to power a mobile device via tools including but not limited to a plug-in dock, tether or electromagnetic mechanisms, or energy from said battery may be used power a computer built into the said transportation device. In other embodiments the power may bypass the battery or no battery may be included at all such that the mobile device is powered simply by being connected to a moving transportation device, via a flywheel, energy converter, and tether, solar panel, and docking station or similar such system. If synergistic mechanisms are used for power, a flywheel may convert said movement to electricity to charge a battery, dock or mobile device directly. Security features may be defined as and may include but are not limited to alarms, cameras, and features involving the locking of the cart or mobile device whether physically or electronically.

There are a variety of embodiments for the uses of data transfer as envisioned in this disclosure. In one embodiment of this disclosure a mobile device may be used to download an application for use with a particular chain of stores. When a user enters a particular store the particular store could be selected by mechanisms including but not limited to pairing with a Wi-Fi or Bluetooth field from the store, GPS, user input, or information transferred from its connection with a cart. The device may have a physical connection with the cart such as a tether or USB plug, electromagnetic connection such as Wi-Fi or Bluetooth, or an electromagnetic connection with the store. Selecting the store may allow the user to see a menu of various items sold there including but not limited to fruits, vegetables, beverages, frozen foods, hot bar items, cookware or breakfast. The user could then drill down in the menu to a particular brand or type of submenu item such as eggs under breakfast. The geolocation capabilities, store director, and price information would be stored within the cart, the store's wifi network, or the supermarket mobile application and could guide the user to the location of the eggs or another grocery store item. In some embodiments the geolocation capabilities could be enhanced by geolocation devices further comprising code scanners, used to scan barcode and store the aisle, row, column, and/or shelf of any inventory. Said geolocation devices could put out a signal picked up by the platform, containing this information. An additional feature could be the ability of the user to select a particular type of eggs or specific brand of a searched item. Subsequently, the gyrometer on the phone is used to guide the consumer to the particular shelf on which the the particular or brand is located. In a variation of this embodiment the mobile device may tether to or plug into a docking station which has a large display screen. The display screen may function as a second screen to the mobile device and show a map of the store in a more ergonomic format, a larger display of data on the mobile device or helpful hints or advertisements that may or may not sync with the mobile device.

In another embodiment the user could preselect items either before or after entering a particular store via creating a shopping list. The application data transfer and geolocation abilities could guide the user from item to item perhaps on a path from nearest to furthest or from non-perishable to most perishable so as to speed up the shopping process and ensure the perishable items don't expire before the user exits the store. In an additional embodiment the mobile device's camera could be used to function as a bar code reader to scan in and purchase or return items without the need for a checkout aisle. In some such embodiments an image of the items in the shopping cart could be required to complete the purchase for store security purposes. In a variation of said additional embodiment the mobile device's camera would still be used as a bar code reader to preselect items on a list, however a checkout aisle would be used for items requiring weight scanning such as fruits or for uploading the final list to. In yet another embodiment the cart itself could be fitted with a weight sensor that allows the user to transmit data regarding the weight of items such as fruit or hot bar items in order to expedite checkout. In other embodiments the cart may be outfitted with its own scanner such that the user does not need a mobile device camera to scan items. In other embodiments the application for transmission of data from the mobile device to the smart cart may record data of what consumer preferences are and suggest additional purchases such as popular cheeses to match a particular wine or dressing to go with a salad. In another embodiment the application would provide real time shopping updates such as what items are sold out, have recently been restocked or would allow users to notify the store of defective carts, expired foods and other store problems all with the touch of a button.

There are multiple embodiments of power transfer envisioned in this disclosure. Power transfer may be accomplished via mechanisms such as converting solar energy to Direct Current (DC) energy to charge a battery, dc energy to ac energy to power a dock or mobile device, AC energy to DC energy to power a battery from a charging station or Kinetic Energy to DC or AC energy to power a battery or mobile device respectively. In one embodiment the rotational movement of the wheels would be transformed from kinetic energy to DC or AC by connecting a flywheel to a battery or docking station respectively, such that as the cart is pushed, the rotation of the flywheel sends electrical energy to the battery for collection or to the docking station for conversion to an acceptable voltage for said mobile device to receive a charge. Energy from a battery could be used for purposes including but not limited to providing additional power to push the carts other wheels or push a group of carts, remote control of a cart to return it to a docking station or the store via manual or autonomous mechanisms, supplying power to a built-in cart scanner, providing power to a built in docking station, providing power to a connected mobile device or providing power to another battery.

In another embodiment carts may dock at a solar shopping cart corral where an overhead solar panel or series of panels is used to provide power to charge the battery or a plurality of batteries on a cart or plurality of carts docked there. When a cart's battery is fully charged the power could be used to light an indicator on the cart, which could dissipate or remain lit such that a user knows when it has or runs out of power. The DC power in the battery may be used in conjunction with synergistic energy collected from the movement of the cart or the cart could instead require a recharging at the solar station or another outlet when it's power dissipates. This power could then be sent to a mobile device via wired or wireless charging such as a charging pad in the form of a docking station. This power can also be used to send out an electromagnetic signal including but not limited to Wi-Fi, Bluetooth or similar signal from the location of the cart.

This disclosure also describes several embodiments for using the cart's security features for protecting the store or the user. This may be accomplished in a variety of ways including but not limited to protecting the user's mobile device with an alarm, locking the cart in place if it moves to a location outside of the store's Wi-Fi or Bluetooth range, or utilizing the phones cameras or a camera on the cart and or those in store to take images of users who shoplift, or those who steal pre-purchased items from the cart of another. In one embodiment a user selected password for locking the mobile device may be required through the application before untethering with a cart or unplugging from a cart docking station. If the user's mobile device is removed from the cart without first unlocking it, an alarm on the cart or the mobile device sounds or flashes. This alarm could also be a signal alerting nearby cameras to lock into the position of the cart so as to quickly locate and identify any mobile device thief. In another embodiment items wouldn't be pre-purchased, only scanned. The idea is that since the items are scanned their purchase would be recorded and the bill would be tabulated as you shop. In such embodiments a user could modify or change the final purchase before checking out. In some such embodiments a user would still need to check out, but since everything is tabulated they would only need to pay the total at the end.

In other embodiments a locking mechanism may be used to keep the carts from leaving a predetermined range, and communicated to the carts via electromagnetic mechanisms. The cart may also send out a signal such that the store may locate the removed device. In another embodiment the camera on the mobile device or in the cart itself may be used to identify items that are loaded into the cart or taken from the cart. A picture of the cart with the items finalized in purchase may be required before completing checkout and untethering or undocking the mobile device. In another embodiment where the phone is tethered or docked to the cart and the mobile device is a cell phone, communication with the cart may be maintained by mechanisms including but not limited to Wi-Fi, Bluetooth, or a tether such that the user can continue to push the cart and in some instances, receive the same functionality from the display on the cart. In some variations the cart or app could then sound an alarm if the user doesn't return the phone to the dock within a preset amount of time, a silent alarm could also be used to notify cameras to follow the cell phone holder as they move towards the exit. This last security feature would be used to prevent someone from stealing a cell phone from an unattended cart that just happens to get a call at that time. However, a loud alarm might prove difficult in instances where a user receives an emergency call such that this optional feature would be unnecessary unless a user notifies security that their phone has been stolen.

Exemplary embodiments disclosed herein may provide a user-friendly shopping experience in a physical store or supermarket through the use of electronically assisted carts and their interfacing mobile devices. While certain exemplary embodiments of the invention are shown in the accompanying drawings, it is still to be understood that said embodiments are susceptible to modification and alteration.

### BRIEF DESCRIPTION OF THE DRAWINGS

Referring to the drawings, FIG. 1 is an illustration of an exemplary transportation device with a battery mounted to it for the storage of energy.

FIG. 2 illustrates an exemplary transportation device tethered to a mobile device.

FIG. 3 illustrates an exemplary transportation device with a mobile device docked to it.

FIG. 4 illustrates an exemplary solar docking station for multiple transportation devices, adjacent to a store.

FIG. 5 illustrates an exemplary Graphical User Interface (GUI) of a potential navigational directory for locating items within a supermarket.

FIG. 6 illustrates an exemplary embodiment in which a user is directed by their Bluetooth docked mobile device, to a set of wrenches in a home improvement store.

FIG. 7 illustrates an exemplary embodiment of a supermarket with several solar panels on the roof for charging any transportation devices located therein.

FIG. 8 illustrates an exemplary embodiment of a hardware store with several solar panels on the roof for charging any transportation devices docked to a docking station in the underground parking garage.

FIG. 9 is an exemplary flowchart showing the typical database hierarchy with data sent to and from a mobile device using an application.

FIG. 10 illustrates an exemplary embodiment of a GUI of a potential navigational directory for locating items within a hardware store, said GUI further comprising space for advertising and coupons.

FIG. 11 is a depiction of an exemplary master-scanner interface in which a cart may be outfitted with a master-scanner transmitter which communicates which inventory has yet to be scanned to the master scanner before the cart passes through.

### DETAILED DESCRIPTION

Generally, exemplary implementations of the principles disclosed herein may include carts, defined as carrier compartments with wheels, that may be used to collect energy through mechanisms including but not limited to synergistic motion, solar power, or plugging in to a power source and transfer that energy to a device including but not limited to a docked cell phone, tethered headset, or wireless communication mechanisms. These exemplary implementations may also involve a cart or network of carts that can transfer data to a synchronized device or plurality of devices, such that information including but not limited to prices, geolocation, security, coupons, sales, weight, savings or user implemented commands may be transmitted to, from or between any physically and/or electronically connected devices.

An exemplary embodiment of the disclosure relates to transportation devices, areas and mobile devices designed to transfer energy and information between one another, specifically information related to the navigation of the area and the locating and processing of particular items of inventory in that particular area. For example, the systems may include a shopping cart which charges a connected cell phone based on the collection of energy from a mechanical flywheel storage device while moving a shopping basket which connects a user augmented reality headset mobile device to the store's inventory and navigates them to selected inventory; a shopping cart with a docking station allowing a user to weigh and scan selected inventory for purchasing on a built in scanner and scale; a group of carts which charge their batteries in a domed docking station, supplied with energy by solar panels; or an application (app) on a mobile device which allows select users to update store inventory and geolocation while working in tandem with other devices in the area to provide navigational assistance and guidance towards selected inventory. In some embodiments the geolocation capabilities could be enhanced by geolocation devices further comprising code scanners, used to scan the barcode and store the aisle, row, column, and/or shelf of any inventory. Said geolocation devices could put out a signal picked up by the platform, containing this information. In some embodiments one or more relay devices may be needed to provide guidance to a user of an app on their mobile device within a store. In other embodiments the app may be built into the docking station of a transportation device such that no mobile device is needed. In yet other embodiments the docking station may be able to be used in tandem with a variety of mobile devices via a direct connection, tether or electromagnetic connection. In some such embodiments the docking station may be used for security features. Security features may be defined as and may include but are not limited to alarms, cameras, inventory scanners, and features involving the locking of the cart or mobile device whether physically or electronically. In some such embodiments the docking station may be used to provide more audible audio guidance or a larger more visible visual guidance to a user than would be possible on their mobile device, which may also be used with the app. independent of the transportation device. In some exemplary embodiments security features may involve the detection of unaccounted merchandise via means including but not limited to a master-scanner that scans a cart's master-scanner transmitter for any unaccounted for merchandise, magnetic or passive electronic chips which may be located on inventory and record data regarding whether or not they've been scanned for payment, a master-scanner that has a conveyor track to load one or more carts through and detect whether the chips on all inventory therein has been scanned for payment without the need for human propulsion, or any combination therein.

In this disclosure the term ‘intelligent transportation device’ refers to an apparatus which may be composed of any or any combination of devices including but not limited to: shopping carts (including shopping carts comprising a flywheel, battery, tether, electromagnetic connection device, solar panels, tether, docking station, or onboard digital directory or any combination therein), shopping baskets (which may be outfitted with similar features as were described with the shopping carts) or similar devices for the transportation of goods while shopping. In some embodiments transportation devices may have a flywheel located on one wheel, such as a rear left wheel of a shopping cart, in others it may be located on a plurality of wheels if one is equipped at all. In some such embodiments the flywheel(s) may be electrically connected to a docking station to ensure it is powered. In other embodiments the flywheel(s) may feed a tether which can send said energy to a mobile device. In yet other embodiments the flywheel(s) may send kinetic energy to a battery, which may be located in positions including but not limited to the front or the rear base of the cart, and may down convert said energy to an acceptable voltage and amperage for a tethered, docked, or electromagnetically connected mobile device. In additional embodiments no flywheel may be included at all and said mobile devices may be charged via a battery which was charged by mechanisms including but not limited to a solar panel on the transportation device, a docking station with solar roofing which the transportation device was plugged into the previous night, a plug in the wall of a store which charges carts by mechanisms of solar paneling on the roof, or a basement garage charging station which similarly feeds solar energy from the roof paneling to the solar docking station located in the basement garage. In certain embodiments a synergistic battery may be used in lieu of a flywheel. Said synergestic battery could be used to store the rotational energy of the cart and transmit it back to any number of devices including but not limited to on board computers, code scanners, charging docks or tethers to power a linked device.

The mobile device may be a device which may receive, process, store, or transmit information. A mobile device may include but is not limited to cellular phones, tablets, intelligent watches, and virtual or augmented reality headsets. In some embodiments a mobile device may be used to run an app which collects information from the mobile device with users' permission related to consumer preference. In some such embodiments the app may record data of what users buy or may assist users in checking off a shopping list by navigating to them in order including but not limited to the order of the list, the order of nearest to farthest, or the order of least perishable to most perishable item. In other embodiments the app may update information related to consumer preferences and store inventory in real time by feeding data between mechanisms including but not limited to transportation devices, a store intranet or the internet. In other embodiments the app may be used to find coupons for selected items based on store specials or if not tied to a particular store, nearby store specials. In additional embodiments the app may allow for quicker check out of users by showing the exact aisle and location of items in the store while guiding users there, allowing users to scan in information including but not limited to barcodes, QR codes and UPC numbers for items, allowing users to input card information, demarking which products have been purchased or not and working in tandem with store security systems via electromagnetic mechanisms including but not limited to store Wi-Fi, device Bluetooth, etc. and causing the system to alarm when an item not purchased is carried out of the store, or reminding the user on their app that a silent alarm will be issued if they do not pay for said item within a certain period of time.

An area may be a store, group of stores or a store/group of stores and the surrounding area including but not limited to a supermarket, department store, hardware store, electronics store, all stores of a particular type within a particular radius, a shopping mall, a store and it's adjacent parking lot, or a series of stores and their connected garages. In some embodiments a user may retrieve a transportation device in a mall parking lot and be guided to the store as well as the location of the store inventory on their shopping list by the transportation device's built in dashboard or by an app on their phone. In other embodiments a user may be instructed that an item they desire is not at a particular store, the app may provide suggestions of related alternatives or the location of other stores nearby from which the user may obtain said item. In additional embodiments a transportation device such as an electric wheelchair with a basket may be charged in the garage of a large facility housing a department store, said transportation device autonomously guiding the user to the selected department store, locating the nearest elevator and avoiding foot traffic as necessary.

In certain exemplary embodiments transportation devices may guide themselves autonomously to docking stations or charging ports when users are done with them or when left idling for a period of time such as an hour. In exemplary embodiments transportation devices may send a signal to a specialized user including but not limited to an owner, retailer or manufacturer that it is time for maintenance after tracking sensors on the device detect it is not operating as efficiently as it once did, a certain time interval has passed or by other mechanisms. In additional exemplary embodiments in order to remove or place a mobile device on transportation device a user will have to enter a particular code. In some such embodiments the same code that a user inputs to dock their mobile device must be used to remove it for purposes of security. In other such embodiments an alarm may sound if the device is forcibly removed. In certain additional embodiments the transportation device may have an indicator, including but not limited to one that provides visual, audio or tactile notifications, that a docked or tethered mobile device has finished charging. In additional embodiments an area may comprise a shopping cart corral which locks the most recently returned carts and releases the first carts stored there, such that the transportation devices receive relatively equalized wear and tear. In some embodiments the app may transfer data from a mobile device such as a user's “notes” or a word processing document and convert the data into a readable format, which lists items to be purchased in an orderly fashion. In certain preferred embodiments a charging station in an area may have a track built to connect to other shopping carts at the base, whereas in other embodiments charging strips may be utilized on the sides of a docking station to ensure that if one cart malfunctions, subsequent carts may be charged through the charger strips. In certain preferred embodiments the app may have a built-in scanner to scan items through the mobile device's camera or the transportation devices own scanner. This scanner may be protected by a physical shielding or designed a safeguard (including but not limited to a curved design for precipitation roll-off, a weatherproofing seal, or vents that may be opened for visibility or closed) to prevent damage from factors including but not limited to rain, misuse, wear and tear, as well as adverse weather conditions. In some such preferred embodiments store employees may be given a special code for maintenance of the transportation devices peripherals such as scanners, docking stations and batteries, and if any transportation devices or associated components are tampered with, without the user entering a code, an alarm may sound. In other preferred embodiments a transportation device and docking station or mobile device app may correlate items purchased by a particular user and store the information in a database to suggest additional advertisements based on consumer preferences. In other preferred embodiments a transportation device may have a retractable covering which can be activated by users to ensure items can't be taken from the basket by another patron. In some such preferred embodiments the removal of the covering may require a code. In other such preferred embodiments if a transportation device remains uncovered and in one location for an extended period a signal may be sent to store surveillance or other security system to ensure the transportation device is not stolen or that the user has not forgotten it or had a health emergency requiring immediate attention.

An embodiment of the present disclosure is displayed in FIG. 1, which provides an illustration of a transportation device with a battery mounted to it for the storage of energy. A transportation device 100 (e.g., a shopping cart), is affixed with a battery 102, in its undercarriage, which may be fed by mechanisms including but not limited to a flywheel, solar energy or may itself be synergistic so as to feed energy to the cart, it's docking station or a tethered device.

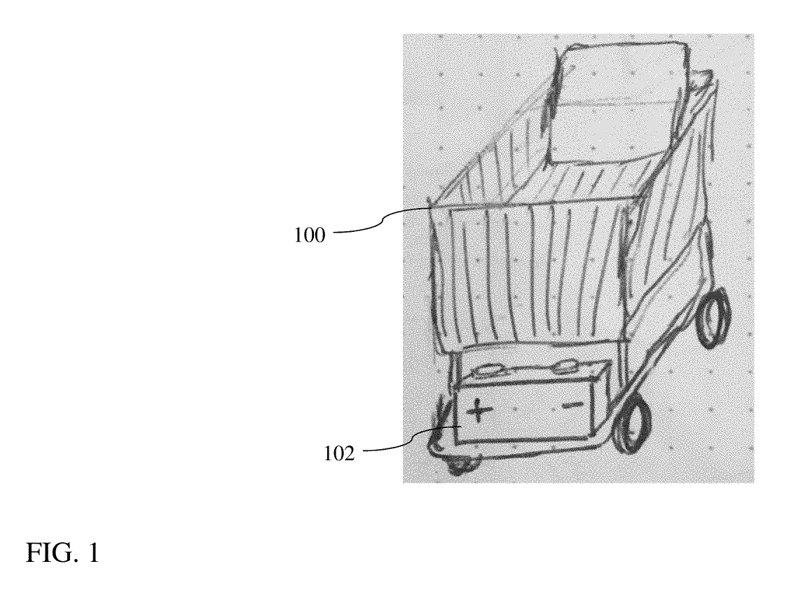

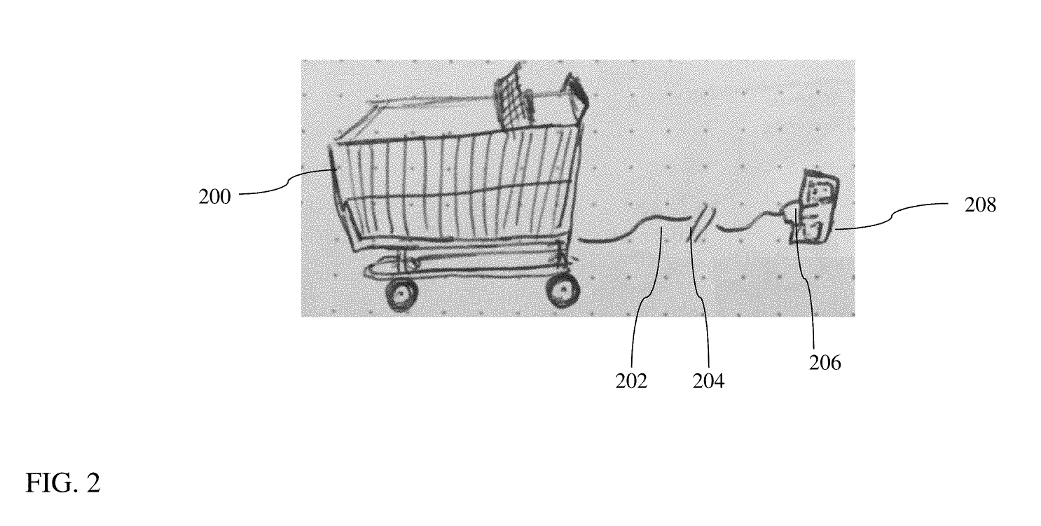

Another embodiment is displayed in FIG. 2, where a cart 200, is tethered, 202, to a mobile device, 208 (e.g., a cell phone.) In some embodiments the connection may be electromagnetic, 204, in others, the connection may be physical 206 and allow a user to charge the mobile device while the tethered cart is in motion, or from its associated battery device.

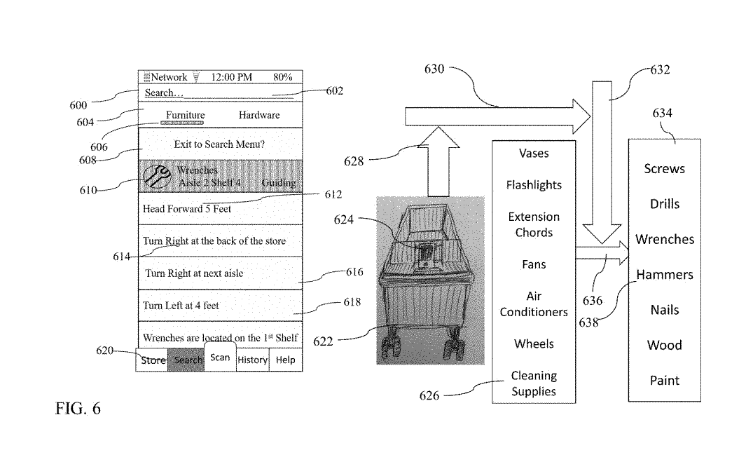

Another embodiment of this disclosure, as displayed in FIG. 3, may be an intelligent transportation device 300 including a docking station (which may also be referred to as a charger dock), 302, said docking station housing a mobile phone, 304, which may be charged by electricity sent from a flywheel 306 to the docking station 302, when the cart 300 is in motion.

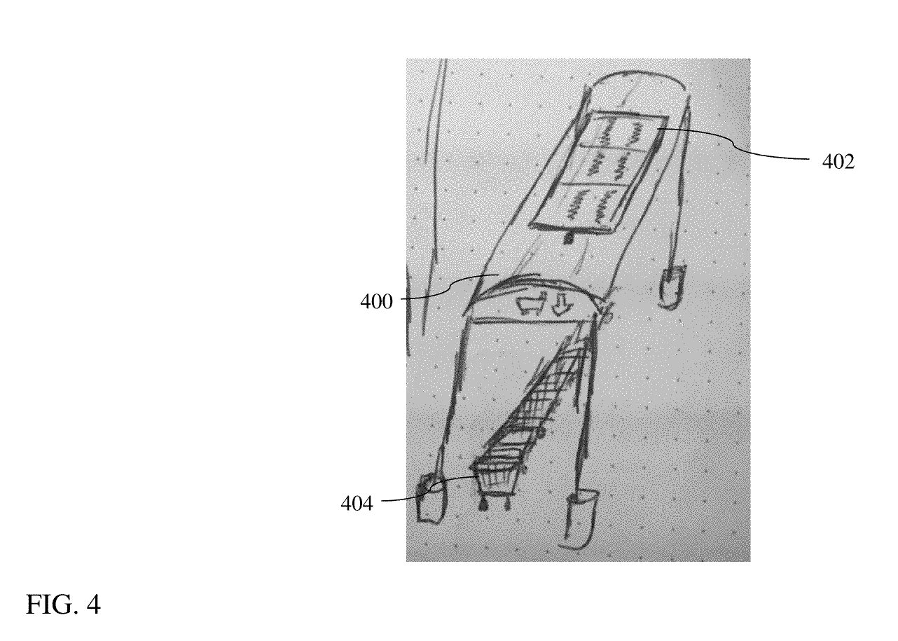

Yet another embodiment of this disclosure is displayed in FIG. 4, wherein a docking station 400, further comprising solar panels 402, which are used to charge docked intelligent carts 404, either directly through wired mechanisms or through a battery. In some such embodiments docked carts may charge through electrical brushes connected directly to the cart's adjacent battery. In other such embodiments empty carts which are left in idle may autonomously return to said docking station utilizing reserve battery power. In yet other embodiments, users may request a cart using a phone app which syncs to the docking station via mechanisms including but not limited to Bluetooth or Wi-Fi. The cart at the front of the docking station, being the least recently docked cart, would be discharged for the users use, in order to ensure somewhat equalized usage time for such carts in order to reduce premature failures due to life-cycle wear and tear as opposed to infant mortality or random failures of the carts.

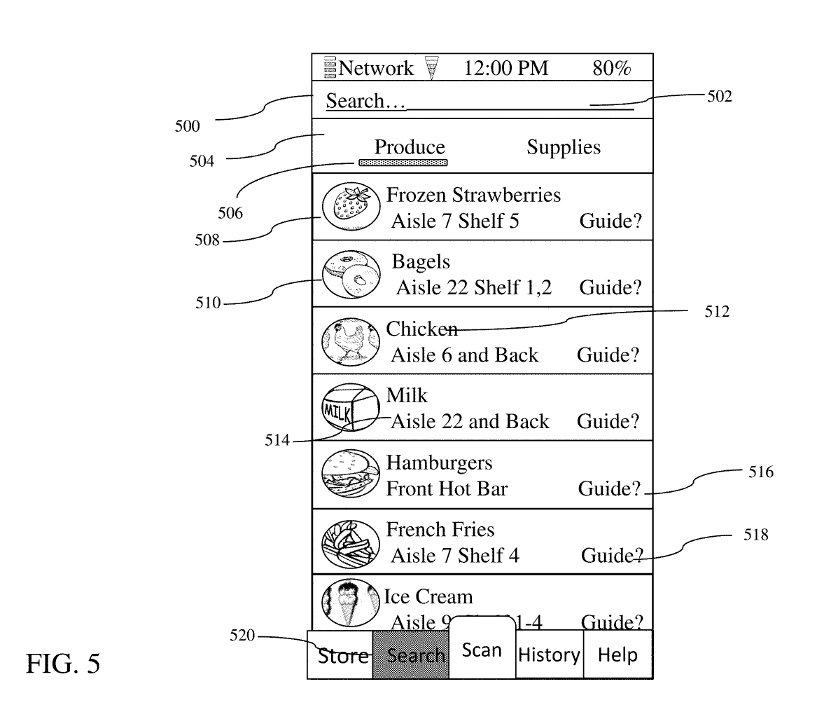

An exemplary embodiment of the aforementioned application (app) on a mobile device is displayed in FIG. 5. The search functionality of the app 500 in this embodiment may include a search bar 502 where a user may type items to search for. In some such embodiments suggestions may be provided based on the text that a user types. A second bar 504 may be included where a user has the choice of selecting between submenu's such as produce and supplies. Here Produce is underlined 506 to show the user that it is selected. In some such embodiments force feedback may be generated when the user selects a submenu. Under the submenu a list of related items 508 may be displayed, including a picture 510 of said items, a written description 512, a location or series of locations 514 and buttons to be guided 516, 518 to said items utilizing navigation which may be provided by mechanisms including but not limited to a series of relays around the store, a digital map of the store coupled with the cellphones infrared sensor, gyroscope, satellite location and/or other similar location or directional mechanisms, or Bluetooth signals from the mobile device or transportation device which measure the feedback from related Bluetooth devices which may be located near items in each aisle and associated with them. A bar may also be included which highlights the selected function, in this case being Search 520. In some embodiments a search may be conducted in a database based on a predetermined rule. Such rules may include but are not limited to returning all results containing a particular word or phrase, returning only the most commonly selected results, or returning only the exact word or phrase searched for.

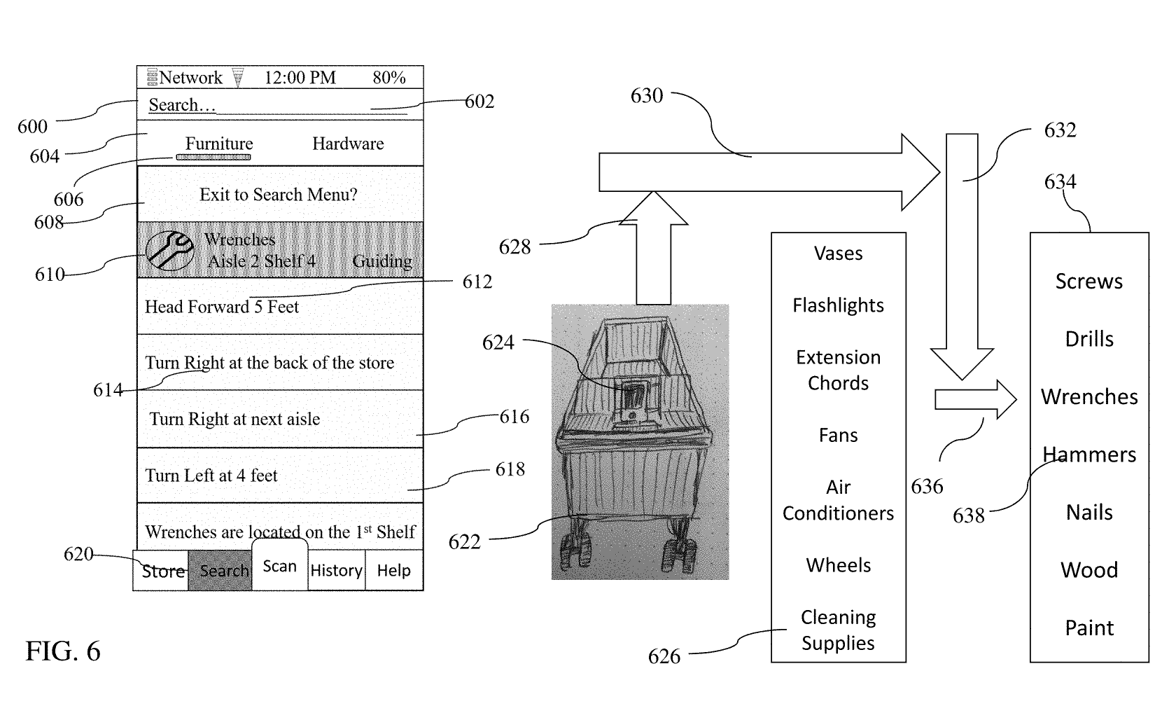

A flowchart of another preferred embodiment of the app and its functionality in navigating a user is illustrated in FIG. 6, which illustrates an app. 600, further comprising a search bar 602, an option to select Furniture or Hardware 604, a highlighted underlining to show which submenu is selected 606, an option to exit the guide to the main sub-menu 608, a highlighted picture and description of the selected item 610 to show it is selected, turn by turn navigation directions 612, 614, 618 and a highlighted button showing which menu is selected 620, in this case the search menu. In some embodiments a user pushing a cart 622, with a connected mobile device 624 may be guided 628, 630, 632 around an aisle 626, and towards another aisle 634, having the wrenches the user is looking for 638, with the gyrometer or other mechanisms guiding the user to the exact shelf 636 of the selected wrenches 638. In some preferred embodiments this guidance may be provided verbally by mechanisms including but not limited to the mobile device or docking station speakers, visually by mechanisms including but not limited to augmented reality glasses or a navigational phone display, or by a combination of mechanisms guiding the user along the path displayed.

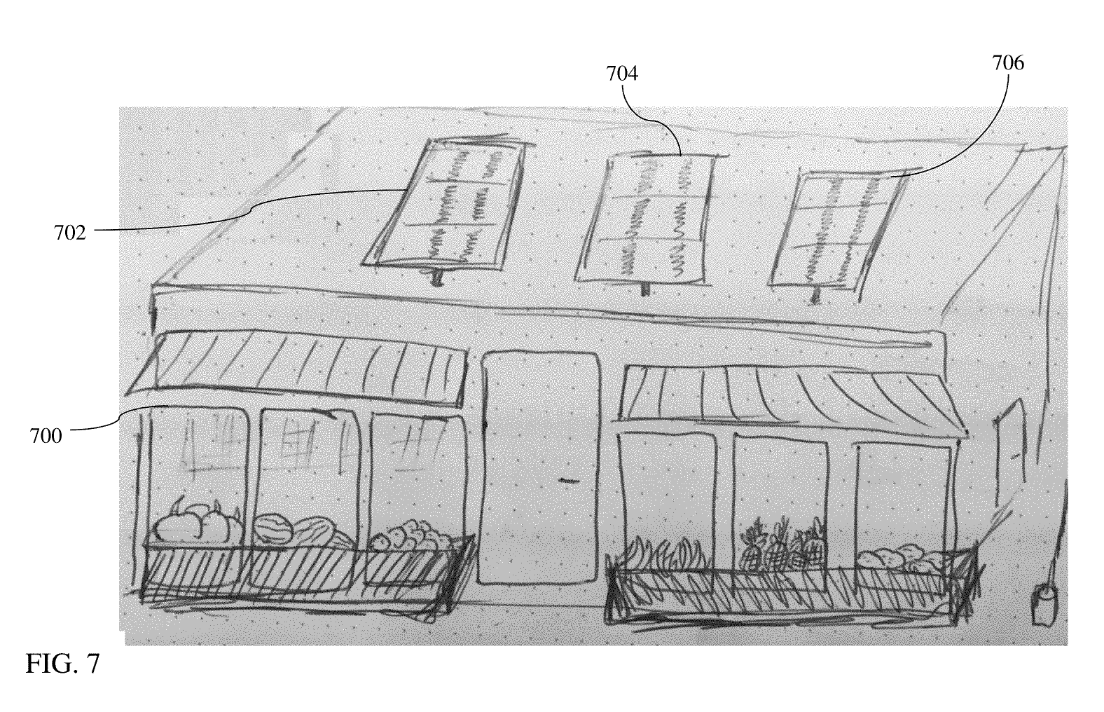

An exemplary embodiment where a store utilizes solar energy to charge the transportation device or related peripherals is displayed in FIG. 7. Here a store 700, with solar panels 702, 704, and 706 which may be mounted on the roof, can be used to feed electricity to any docked carts housed therein or related navigational peripherals by wired mechanisms. In certain embodiments this power may be transferred by wireless mechanisms to the transportation devices batteries such that docking is not necessary to power the devices.

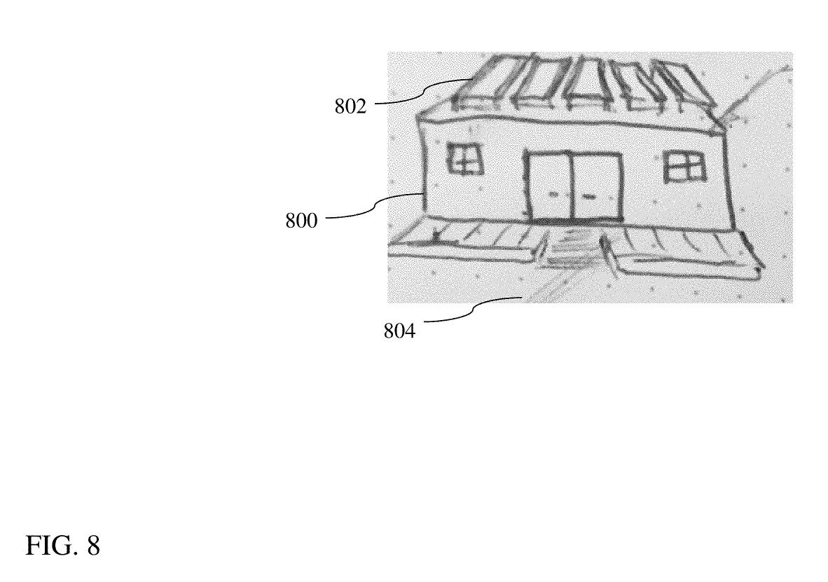

Another exemplary embodiment where a store utilized solar energy to charge transportation devices is displayed in FIG. 8. Here a store 800, with roof mounted solar panels 802, sends the energy by wired mechanisms 804 to docking stations located in the garage, thereby powering any carts docked in the store's underground parking.

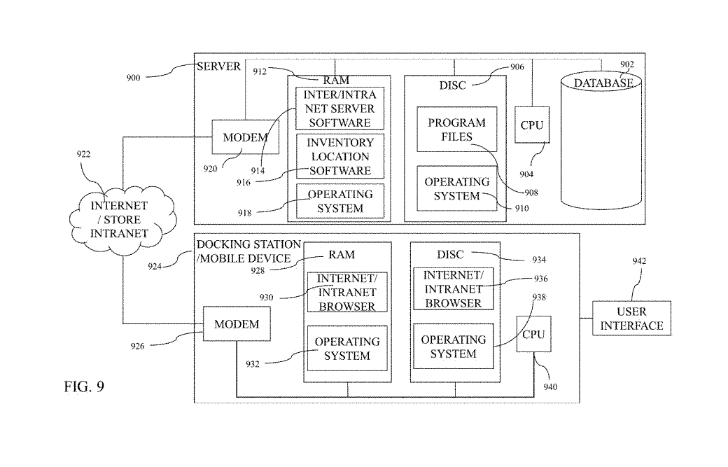

FIG. 9 is an exemplary embodiment following a standard Internet architecture in which user docking station/mobile device 924 and a server 900 are connected via the internet/store intranet 922 and modems 926, 920 or other communications channels. A user accesses the server 900 via their docking station/mobile device 924 operating a web browser 930 or other software application residing in RAM memory 908 that allows it to display information downloaded from a server 900. The server system 900 runs server software 914, including the inventory loading software 916 of the present invention, which interacts with the docking station/mobile device 924 and a user information database 902. The database 902 contains contact information entered by registered users. The inventory location software 116 in some situations will notify any number of users of updates made to the database 902. Both the server 900 and the docking station/mobile device 924 include respective storage devices, such as hard disks 906 and 934 and operate under the control of operating systems 918, 932 executed in RAM 912, 928 by the CPUs 904, 940. The server storage device 906 stores program files 908 and the operating system 110. Similarly, the user storage devices 134 store the inter/intranet browser software 936 and the operating systems 938. Typically, the user would utilize the inventory location software/user interface 942 on their mobile device 924.

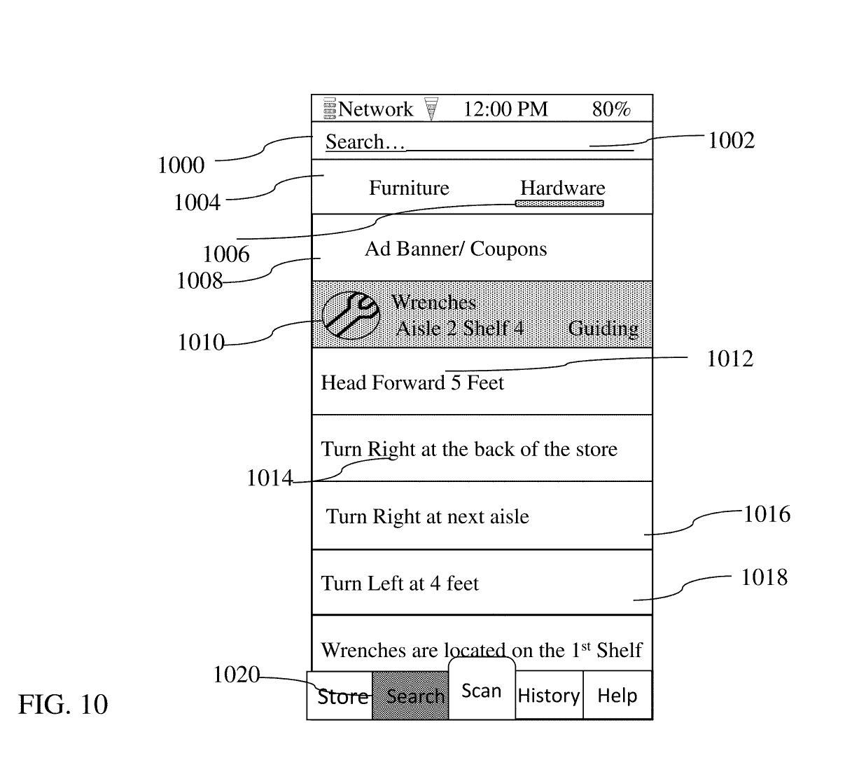

Yet another exemplary embodiment of the disclosure is illustrated in FIG. 10. Similar to part of FIG. 6, an app. 1000, further comprising a search bar 1002, an option to select Furniture or Hardware 1004, a highlighted underlining to show which submenu is selected 1006, an option to select advertisements or coupons 1008 (an alternate option to FIG. 6's exit-panel), a highlighted picture 1010 and description of the selected item 1010 to show it is selected, turn by turn navigation directions 1012, 1014, 1018 and a highlighted button showing which menu is selected 1020 is used to illustrate the interface which a user may utilize to search for and locate items in a store in conjunction with the transportation device of this disclosure.

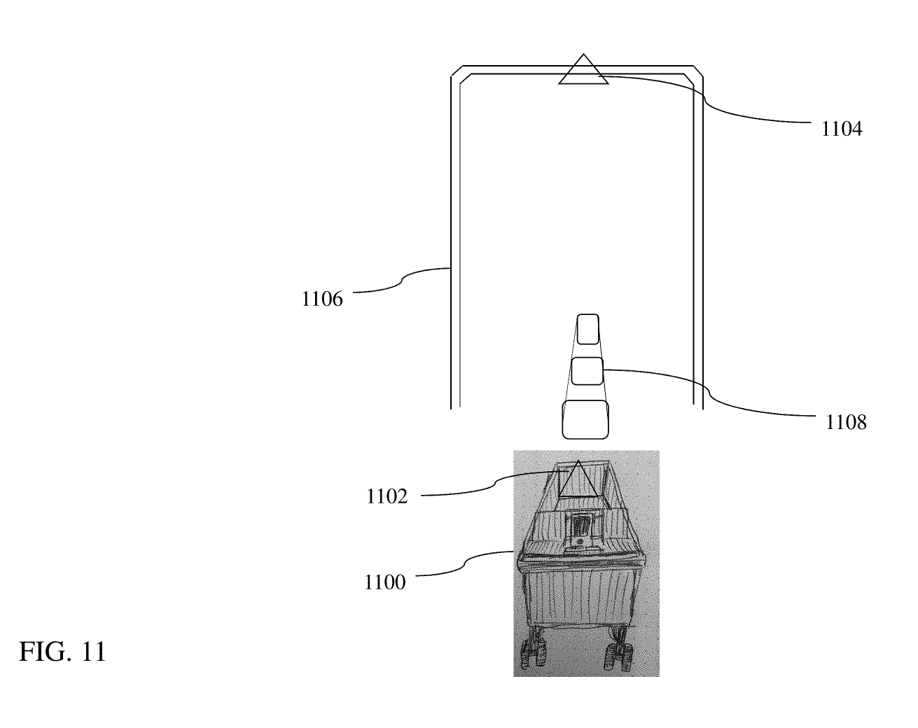

FIG. 11 depicts an additional exemplary embodiment, in which a cart 1100 with a master-scanner transmitter 1102 that sends signals to a master-scanner receiver 1104 indicating whether any inventory in the cart has yes to be accounted for as the cart passes through the master-scanner 1106. In some such exemplary embodiments the cart may pass through the master-scanner without the aid of human propulsion, including but not limited to autonomous movement or a conveyance system 1108.

It is understood that the various exemplary embodiments are shown and described above to illustrate different possible features of the disclosure and the varying ways in which these features may be combined. Apart from combining the different features of the above embodiments in varying ways, other modifications are also considered to be within the scope of the disclosure.

1. A store navigation apparatus comprising:
at least one memory operable to store program code;
at least one hardware processor operable to read the program code and operate as instructed by the program code, the program code including:
inventory location code configured to cause the at least one hardware processor to receive a request from a first user terminal associated with a user, the request to include at least one word or a phrase;
extracting code configured to cause the at least one hardware processor to extract any number of inventory associated with the word or the phrase;
determining code configured to cause the at least one hardware processor to determine the best route to any inventory identified by the word or the phrase; and
output code configured to cause the at least one hardware processor to display the route to the selected inventory on the user terminal of the user.

2. A store inventory processing apparatus comprising:
at least one memory operable to store program code;
at least one hardware processor operable to read the program code and operate as instructed by the program code, the program code including:
inventory input code configured to cause the at least one hardware processor to receive a plurality of inventory input by a user;
extracting code configured to cause the at least one hardware processor to extract information from a database regarding said inventory based on a predetermined rule;
generating code configured to cause the at least one hardware processor to generate feedback related to said inventory; and
output code configured to cause the at least one hardware processor to output the feedback of said inventory on a graphical user interface.

3. A store navigation apparatus as described in claim 1 further comprising an attachment with at least one carrier compartment with a plurality of wheels.

4. A store navigation apparatus as described in claim 3 wherein said attachment is a tether connection or charging dock.

5. A store navigation apparatus as described in claim 3 wherein said attachment is an electromagnetic connection to a mobile device.

6. A store navigation apparatus as described in claim 3 said carrier compartment further comprising a synergistic battery.

7. A store navigation apparatus as described in claim 3 said carrier compartment further comprising a built-in computer containing a store directory with navigation capability.

8. A store navigation apparatus as described in claim 3 said carrier compartment further comprising a code scanner.

9. A store navigation apparatus as described in claim 3 said carrier compartment further comprising a weight sensor.

10. A store navigation apparatus as described in claim 3 said carrier compartment further comprising a master-scanner transmitter.

11. A store inventory processing apparatus as described in claim 2 further comprising an attachment to cart with at least one carrier compartment with a plurality of wheels.

12. A store inventory processing apparatus as described in claim 11 wherein said attachment is a tether connection or charger dock.

13. A store inventory processing apparatus as described in claim 11 wherein said attachment is an electromagnetic connection to a mobile device.

14. A store inventory processing apparatus as described in claim 11 said apparatus further comprising a synergistic battery.

15. A store inventory processing apparatus as described in claim 11 said apparatus further comprising a built-in computer containing a store directory with navigation capability.

16. A store inventory processing apparatus as described in claim 11 said apparatus further comprising a code scanner.

17. A store inventory processing apparatus as described in claim 11 said apparatus further comprising a weight sensor.

18. A store inventory processing apparatus as described in claim 11 said apparatus further comprising a master-scanner transmitter.

19. A method of tying a periodically updated store directory with mobile devices linked to the store's intranet and a smart transportation device, comprising the steps of:
installing geolocation devices further comprising code scanners,
creating a platform that communicate with said geolocation devices.

20. A method as described in claim 19 further comprising the steps of
installing peripheral devices on store carts that communicate with said platform, said peripheral devices being:
one or more code scanners,
any number of weight scanners,
any number of credit card readers,
any number of docking stations,
any number of tether chords,
any number of a master-scanner transmitters,
and
any number of alarm devices.
